(19) United States
(12) Patent Application Publication
(10) Pub. No.: US 2012/0073737 A1
(43) Pub. Date: Mar. 29, 2012

(54) MULTI-SURFACE APPLIQUING METHOD FOR MELAMINE CONTAINER

(76) Inventor: TSUNG-HAN TSAI, Yonghe City (TW)

(21) Appl. No.: 12/892,908

(22) Filed: Sep. 28, 2010

(51) Int. Cl. B32B 37/15; B32B 38/00

(52) U.S. Cl. 156/245

(57) ABSTRACT

A multi-surface appliquing method is provided for a melamine container. The method is process for producing a melamine container that has inner and outer appliques performed with a single mold in a single processing machine. A single mold used in a single processing machine is used to mold a blank formed of a material and the blank provides an adhesion force before being completely cured. The adhesion force is used, together with glitter powders (resin based glitter powders of melamine) adjusted for a different curing time, in such a way that the properties of the two materials, together with producing condition realized through adjusting a hydraulically operated processing machine, allow for production of a melamine container having inner and outer surfaces of applique with a single set of mold.

### (a) TECHNICAL FIELD OF THE INVENTION

The present invention generally relates to a melamine container, and more particularly to a multi-surface appliquing method for a melamine container that is performed with a single mold in a single processing machine to form a melamine container that has inner and outer surfaces of applique.

### (b) DESCRIPTION OF THE PRIOR ART

A regular melamine container, such as bowls or dishes, is formed through a molding process with female and male molding members and a hydraulically operated processing machine. Such a molded melamine container is of a single color. This makes the container monotonous in color and of no variation. Thus, it is often that a so-call “appliquing” process is applied on an outside portion of the container, which attaches an applique layer or texts on an outer circumference of the container to make the container beautiful and valuable.

Conventionally, two sets of molds of different specifications are used with two processing machines. The first set of mold is mounted on the first processing machine to carry out a first appliquing process and then the container is removed and deposited into the mold on the second processing machine to carry out a second time of material feeding and a processing operation of second surface appliquing. With such two sets of mold of different specifications, two-surface appliquing can be realized.

However, there are certain drawbacks existing in the appliquing process with two molds and two machines, such as:

(1) When a product is processed with the first machine, the material of the product must be first cured before it can be removed for being further deposited into the second mold of the second machine and since the material has been cured and hardened, it is no longer possible for re-shaping and re-fusion of materials.

(2) Applique decoration formed in this way is actually of two layers of coating, which are not integrally formed as a one-piece structure.

(3) Since the coating is not a one-piece structure, the product, when dropping or cleaned, is susceptible to cracking or peeling of the coating.

(4) Being subjected to influence of a surrounding temperature or the temperature of a substance received therein, the product is attacked by different heating situation on the outside and inside of the product, which leads to separation of the coating layer and thus deterioration of the product quality

(5) Using two machines is a waste of energy and labor.

(6) The conventional product has only one surface covered with resin-based glitter powders for hardening.

Thus, it is desired to provide a solution to overcome the above discussed problems.

### SUMMARY OF THE INVENTION

In view of the above listed drawbacks of the existing techniques, the present invention aims to provide a multi-surface appliquing method for a melamine container, which is performed with a single mold in a single processing machine to form a melamine container that has inner and outer surfaces of applique.

The primary objective of the present invention is to provide a multi-surface appliquing method for a melamine container, which comprises the following steps:

(a) depositing a material in a mold composed of a male molding member and a female molding member;

(b) heating the material for molding with the male and female molding members being controlled at a temperature difference of ±17° C., whereby after the mold is open, the material for inner appliquing is not completely cured and thus possesses an adhesion force and thus the product blank has a surface that is not cured and possesses certain adhesion force that is capable of attaching the blank to the mold and another surface that is cured and can be separated from the mold;

(c) with the material (the product blank), after the mold being opened, sticking to one of the molding members having a lower mold temperature, positioning a desired applique layer in one of the molding members having a higher mold temperature for performance of appliquing operation;

(d) opening the mold again after completion of the appliquing operation and applying glitter powders to an appliqued pattern sheet and closing the mold to complete appliquing outside the product; and

(e) controlling curing time of the glitter powders so that an appliqued surface is attached, with an adhesion force provided by the glitter powders that are not cured, to the mold to carry out appliquing on another surface.

As such, through the adhesion forces provided by the material, the applique layer is attached to the material, making the material and the applique layer integrated together as a one-piece structure so that it is not easy to separate or crack or peel in cleaning.

Another objective of the present invention is that through use of a single processing machine and a single mold, the consumption of energy and the use of labor can be substantially reduced.

A further objective of the present invention is to increase the aesthetics of product and extend service life of product.

Yet a further objective of the present invention is that inner and outer layer surfaces are covered with resin-based glitter powders that are of high hardness and comply with international hygiene standards, so as to reduce surface hardness of product, reduce abrasion and wear, reduce bacteria attached to and breeding thereon, and thus extend the service life of product.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 shows a flow chart of a multi-surface appliquing method for a melamine container according to a preferred embodiment of the present invention.

FIG. 2 is cross-sectional view illustrating primary hot-pressing according to the present invention.

FIG. 3 is a cross-sectional view illustrating appliquing according to the present invention.

FIG. 4 is a cross-sectional view illustrating application of glitter powders according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

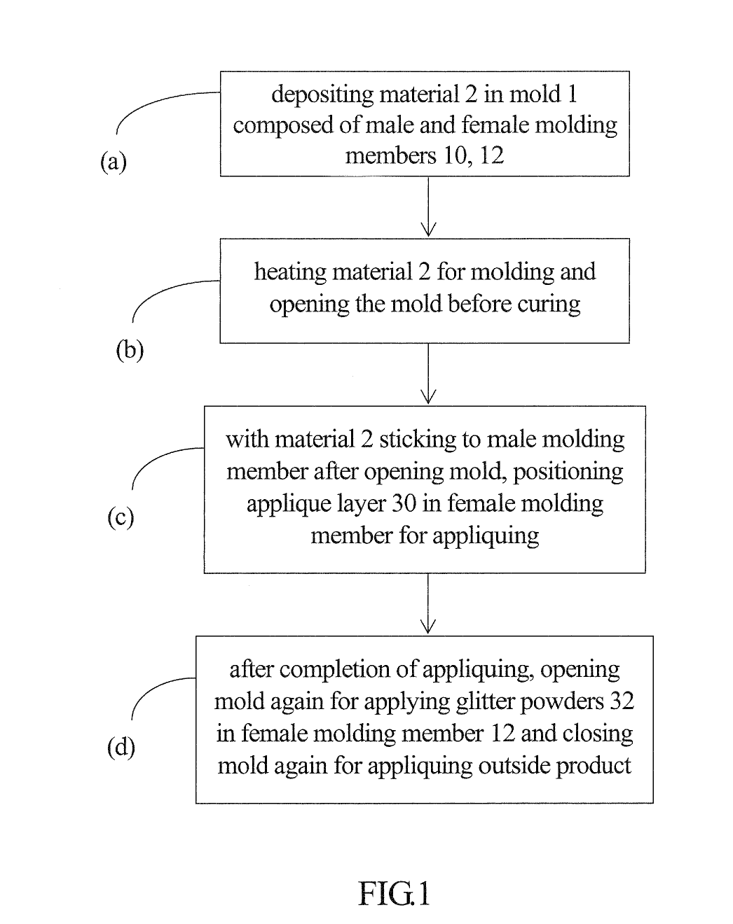

Referring to FIG. 1, which shows a flow chart of a multi-surface appliquing method for a melamine container according to a preferred embodiment of the present invention, which comprises the following steps:

(a) depositing a material 2 in a mold 1 composed of a male molding member 10 and a female molding member 12;

(b) heating the material 2 for molding with the male and female molding members 10, 12 being controlled at a predetermined range of temperature difference, whereby after the mold is open, the material for inner appliquing is not completely cured and thus possesses an adhesion force;

(c) with the material 2, after the mold being opened, sticking to the male molding member 10, positioning a predetermined applique layer 30 in the female molding member 12 for performance of appliquing operation;

(d) opening the mold again after completion of the appliquing operation and applying glitter powders 32 to an appliqued pattern sheet and closing the mold to complete appliquing outside the product; and

(e) controlling curing time of the glitter powders so that an appliqued surface is attached, with an adhesion force provided by the glitter powders that are not cured, to the mold to carry out appliquing on another surface.

In step (e), the glitter powders have a composition that comprises a predetermined ratio of a curing agent so that the curing time of the glitter powders can be controlled through the amount of curing agent added.

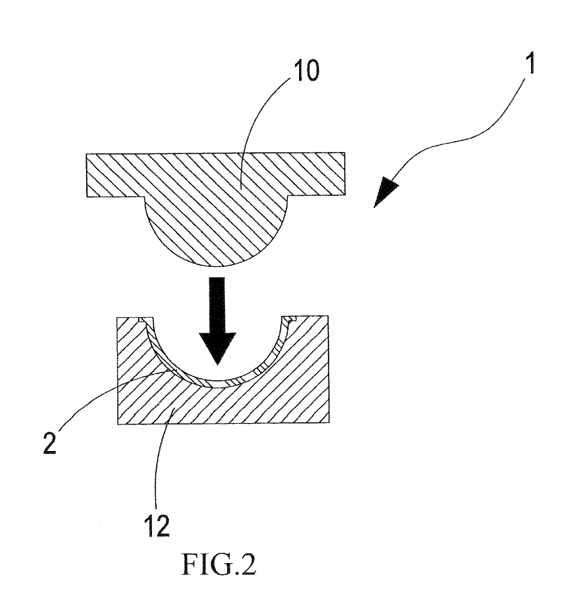

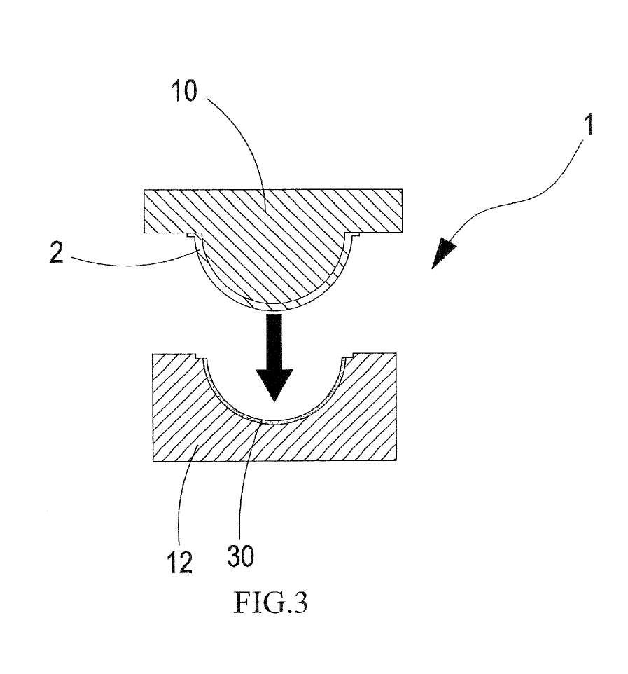

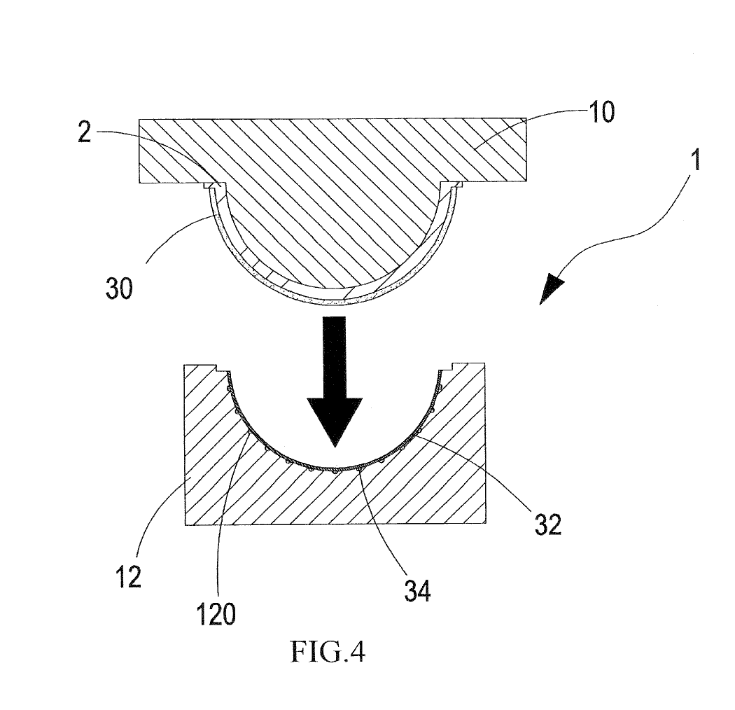

Reference is now made also to FIGS. 2-4, which respectively show a cross-sectional view illustrating primary hot-pressing for molding, a cross-sectional view illustrating appliquing, and a cross-sectional view illustrating application of glitter powders. As shown in the drawings, before the material 2 is deposited into the mold 1, a hydraulically operated processing machine (not shown) is applied to control the working temperature of the mold 1 in such a way that the temperature of the male molding member 10 is made higher than that of the female molding member 12. After the heating operation, the material 2 is then deposited into the mold 1 for hot pressing and molding. The color or material property of the material 2 can be changed as desired by an operator. When the material 2 is heated to a predetermined level of temperature, the material 2 is slightly cured but still possesses a certain adhesion force. At this time, the mold 1 is opened.

Further, since the temperature of the male molding member 10 is higher than that of the female molding member 12, the material 2, which is in a semi-liquid condition, sticks to the male molding member 10. At this time, the operator may position a predetermined applique layer 30 on a product blank of the female molding member 12. Since the female molding member 12 has a lower temperature, when the mold 1 is closed again, the applique layer 30 will not be excessively cured.

After the appliquing operation, the mold is opened again to allow glitter powders 34 (such as regular golden powders) to be uniformly applied to a recess 120 of the female molding member 12 and a pattern sheet 32 is positioned at a proper location. Then, the mold is closed again for heating. The glitter powders 34 require a heating and curing time that is twice of the conventionally used period of time. With such a doubled time period for heating, cracking and peeling of the glitter powders 34 from a finished product can be eliminated. After the heating operation, the mold is opened and a melamine container that has inner and outer surfaces of appliquing can be removed.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A multi-surface appliquing method for melamine container, comprises the following steps:
(a) depositing a material in a mold composed of a male molding member and a female molding member;
(b) heating the material for molding with the male and female molding members being controlled at a predetermined range of temperature difference, whereby after the mold is open, the material for inner appliquing is not completely cured and thus possesses an adhesion force;
(c) with the material, after the mold being opened, sticking to the male molding member, positioning a predetermined applique layer in the female molding members for performance of appliquing operation; and
(d) opening the mold again after completion of the appliquing operation and applying glitter powders to an appliqued pattern sheet and closing the mold to complete appliquing outside the product.

2. The method according to claim 1 further comprising the following step: (e) controlling curing time of the glitter powders so that an appliqued surface is attached, with an adhesion force provided by the glitter powders that are not cured, to the mold to carry out appliquing on another surface.

3. The method according to claim 1, wherein in step (b), heating is performed by using a hydraulically operated processing machine to control temperature in such a way that the male molding member has a temperature that is higher than a temperature of the female molding member.

4. The method according to claim 1, wherein in step (b), the predetermined range of temperature difference is ±17° C.

5. The method according to claim 1, wherein the material is selectively changed for color or property.

6. The method according to claim 1, wherein in step (d), the glitter powders are cured with a doubled curing time.

7. The method according to claim 1, wherein the female molding member forms a recess.
